(19) United States
(12) Patent Application Publication
(10) Pub. No.: US 2015/0186676 A1
(43) Pub. Date: Jul. 2, 2015

(54) REAL-TIME CLOCK (RTC) MODIFICATION DETECTION SYSTEM

(71) Applicants: Mohit Arora, Faridabad (IN); Prashant Bhargava, Gurgaon (IN); Pradip Singh, Noida (IN)

(72) Inventors: Mohit Arora, Faridabad (IN); Prashant Bhargava, Gurgaon (IN); Pradip Singh, Noida (IN)

(21) Appl. No.: 14/145,991

(22) Filed: Jan. 1, 2014

(51) Int. Cl. G06F 21/64

(52) U.S. Cl. CPC G06F 21/64

(57) ABSTRACT

A system for securing a real-time clock (RTC) of an electronic device includes a RTC counter that counts clock pulses of a RTC signal generated by a crystal oscillator, and a reference-time register that periodically stores a reference time value generated by a network-clock generator. A hash-value generator uses a predefined hash algorithm to generate first and second hash values based on the reference time value and the count of the RTC counter, respectively, at predetermined time intervals. A comparator compares the first and second hash values and generates a trigger signal when there is a mismatch.

### BACKGROUND OF THE INVENTION

The present invention generally relates to electronic devices, and, more particularly, to a system for detecting modification of a real-time clock (RTC) of an electronic device.

Several electronic systems or devices including point-of-sale (POS) terminals, vending machines and security-related equipment need to keep a track of time. These devices include a software system that generates a system clock to maintain a system time when the electronic device is operating. The electronic devices further include a processor that use the system time to perform functions such as scheduling internal processes, time-stamping files, and so forth. However, when the electronic device is powered off or enters a sleep-state, the system clock shuts down. Therefore, the electronic devices include a hardware reference clock that initializes the system time when the electronic device starts up. A real-time clock (RTC) is an example of a hardware reference clock that is powered by an external battery. Most RTCs use a 32.768 KHz external crystal oscillator and maintain a real time (also known as wall time) even when the electronic device is off. The RTC updates the system time whenever the system clock drifts from the RTC time.

The RTC is prone to hacking. A hacker can tamper with the RTC of an electronic device, for example, an electric meter that measures household electric consumption, and manipulate units consumed in a day by changing the real time, which in turn changes the system time. Hence, the RTC must be secured to protect it from being hacked.

Existing electronic devices use software or firmware modules to secure the RTC. FIG. 1 shows an example of a conventional electronic system 100 including a RTC circuit 102, a network-clock generator 104, a reference time register 106, and a software (or firmware) module 108. The RTC circuit 102 includes a crystal oscillator 110 and a RTC counter 112. The software module 108 includes a comparison module 114.

The crystal oscillator 110 generates a RTC signal. The RTC counter 112 receives the RTC signal and counts a number of clock pulses of the RTC signal (also known as clock values). The count represents the real time. The network-clock generator 104 is synchronized with an external network time server (not shown) and generates network or reference time values and the reference-time register 106 periodically stores the reference time values. The crystal oscillator 110 can be manipulated so that the RTC counter 112 counts fewer clock pulses. In such a scenario, the clock values counted by the RTC counter 112 do not match the reference time values stored by the reference-time register 106. The comparison module 114 compares the clock and reference time values and generates a trigger signal if the values do not match. The trigger signal prompts the electronic system 100 to delete any secured or critical information stored in a memory (not shown) of the electronic system 100, such as, copy of symmetric keys used for decrypting encoded information stored in the electronic system 100 memory.

However, the above solution suffers from a drawback in that software modules are vulnerable to security loop holes and can be easily hacked. That is, the software module 108 can be accessed and manipulated such that the comparison module 114 does not generate a trigger signal when the clock and reference time values do not match. Hence, the secured and critical information does not get deleted and so can be accessed by the hacker.

Therefore, it would be advantageous to have a system for with a more secure RTC.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram of a conventional system for securing a real-time clock (RTC) of an electronic system;

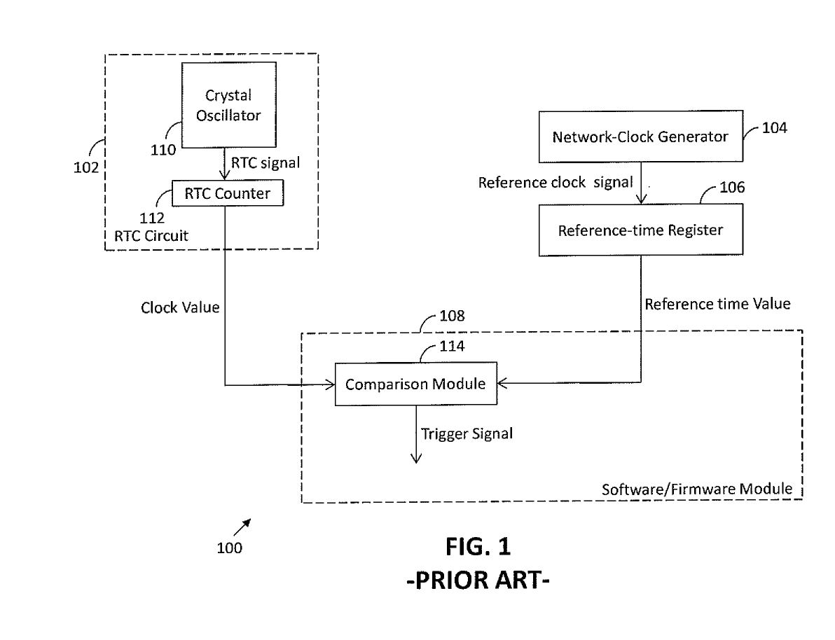

FIG. 2 is a schematic block diagram of a hardware module for securing a real-time clock (RTC) circuit of an electronic system in accordance with an embodiment of the present invention; and

FIG. 3 is a flow chart illustrating a method to secure the RTC of FIG. 2, in accordance with an embodiment of the present invention.

### DETAILED DESCRIPTION OF THE PRESENT INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a system for detecting modifications to a real-time clock (RTC) of an electronic device is provided. The system includes an RTC counter, a reference time register, a hash-value generator, and a comparison module. The RTC counter receives an RTC signal and outputs a plurality of clock values that correspond to a plurality of clock pulses of the RTC signal. The reference-time register receives and stores a plurality of reference time values at a first predetermined time interval. The hash-value generator is connected to the reference-time register and the RTC counter and generates a first hash value based on a first reference time value of the plurality of reference time values and a second hash value based on a first clock value of the plurality of clock values. The first and second hash values are computed based on a predetermined hash function and at a second predetermined time interval. The comparison module is connected to the hash-value generator and compares the first and second hash values and generates a trigger signal based on a mismatch between the first and second hash values, whereby the mismatch indicates modifications to the RTC.

In another embodiment of the present invention, a method for detecting modifications to a real-time clock (RTC) of an electronic device is provided. The electronic device includes an RTC counter, a reference time register, a hash-value generator, and a comparison module. The method includes receiving an RTC signal by a RTC counter. A plurality of clock values that correspond to a plurality of clock pulses of the RTC signal is outputted by the RTC counter. A plurality of reference time values is received by the reference-time register at a first predetermined time interval. A first hash value is generated based on a first reference time value of the plurality of reference time values, by a hash-value generator that is connected to the reference-time register and the RTC counter. The first hash value is generated based on a predetermined hash function and at a second predetermined time interval. A second hash value is generated based on a first clock value of the plurality of clock values, by the hash-value generator. The second hash value is generated based on the predetermined hash function and at the second predetermined time interval. The first and second hash values are compared by using a comparison module that is connected to the hash-value generator. A trigger signal is generated by the comparison module, based on a mismatch between the first and second hash values, whereby the mismatch indicates modifications to the RTC.

Various embodiments of the present invention provide a system for securing a real-time clock (RTC) circuit of an electronic device. The electronic device includes a reference-time register and a hardware module that includes a hash-value generator and a comparison module. The RTC circuit includes a RTC counter that receives a RTC signal from a crystal oscillator and counts a plurality of clock values corresponding to the RTC signal. The reference-time register receives and stores a plurality of reference time values that are generated by a network-clock generator at a first predetermined time interval. The hash value generator uses a predetermined hash function and generates a first hash value based on a first reference time value of the plurality of reference time values and a second hash value based on a first clock value of the plurality of clock values at a second predetermined time interval. The comparison module compares the first and second hash values and generates a trigger signal when there is a mismatch. A mismatch in the hash values indicates that either the RTC circuit has been manipulated (by tampering the crystal oscillator) or the reference time values have been altered. The trigger signal prompts the electronic device to immediately delete any security information that may be stored by the electronic device. Further, the hash-value generator keeps generating new first and second hash values at regular time interval which renders it impossible for the hacker to manipulate the reference time values and the count values at the same time. As the hash values cannot be traced back by reverse engineering, the hardware module of the present invention is reliable as opposed to conventional systems that use software or firmware modules securing the RTC, which can be easily manipulated and are vulnerable to security loop holes. Further, the system of the present invention is tolerant to clock drifts as they last only for a few milliseconds and do not interfere in the comparison process.

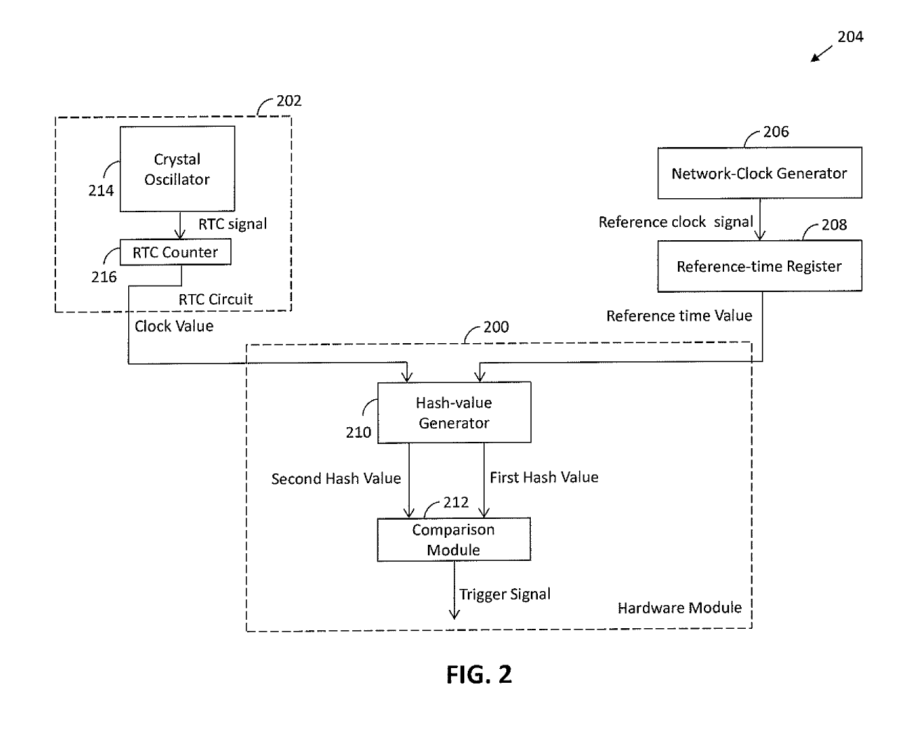

Referring now to FIG. 2, a schematic block diagram of a hardware module 200 for securing a real-time clock (RTC) circuit 202 of an electronic system 204 in accordance with an embodiment of the present invention is shown. The hardware module 200 and the RTC circuit 202 are a part of the electronic system 204 and the electronic system 204 further includes a network-clock generator 206 and a reference-time register 208. The hardware module 200 includes a hash-value generator 210 and a comparison module 212. The RTC circuit 202 includes a crystal oscillator 214 and a RTC counter 216. Examples of the electronic system 204 include point-of-sale (POS) terminals, vending machines, security-related equipment, and so on and examples of the hardware module 200 include a microprocessor, a microcontroller unit (MCU), a system-on-chip (SOC), and an application specific integrated circuit (ASIC).

The RTC circuit 202 may be powered by an external battery (not shown) and tracks the real time which is used by different applications of the electronic system 204. The crystal oscillator 214 generates a RTC signal that has a predetermined frequency (e.g., 32.768 KHz) and the RTC counter 216 receives the RTC signal and counts a number of clock pulses of the RTC signal (also known as clock values). The count represents the real time. The network-clock generator 206 tracks a network time by synchronizing with an external network time server (not shown) and generates a plurality of network or reference time values. The reference-time register 208 receives the reference time values from the network-clock generator 206 at a first predetermined time interval by way of a suitable networking protocol including network time protocol (NTP) and stores the reference time values. In an embodiment of the present invention, the first predetermined time interval may be chosen based on system requirements (e.g., thirty seconds). The reference-time register 208 is a write-only register which prohibits the hacker from accessing the reference time values. When the electronic system 204 is switched ON, the RTC counter 216 synchronizes with the network-clock generator 206 and initializes a system time of the electronic system 204 based on the network time. In various embodiments of the present invention, the RTC counter 216 synchronizes with the network-clock generator 206 using protocols including NTP, global-positioning system (GPS), and so on.

The hash-value generator 210 is connected to the reference time register 208 and the RTC counter 216 and receives a first reference time value and a first clock value, respectively and generates a first hash value based on the first reference time value and a second hash value based on the first clock value by using a predetermined hash function at a second predetermined time interval. The second predetermined time interval may also be chosen based on system requirements (e.g., thirty seconds). The hash-value generator 210 may use any suitable hash function that is known in art. An example of such a hash function is a secure hash algorithm (SHA)-256. In an embodiment, when the hash-value generator 210 uses the (SHA)-256 function, the first reference time and clock values are extended to 64 bits by padding zeroes. The hash-value generator 210 receives 64-bit first and second input values and generates corresponding 256-bit first and second hash values.

The comparison module 212 compares the first and second hash values and generates a trigger signal in case the hash values do not match. The first and second hash values may not match if a hacker has altered the reference-time value by manipulating the reference time values generated by the network-clock generator 206. The hacker may also manipulate the crystal oscillator 214 such that the RTC counter 216 counts less number of clock pulses, in which case the first and second hash values do not match.

The trigger signal is used as an indication by the electronic system 204 to raise an alarm and delete any secured or critical information that is stored in a memory (not shown) thereof. The first and second hash values cannot be reverse engineered, thereby rendering the RTC circuit 202 foolproof as compared to conventional systems.

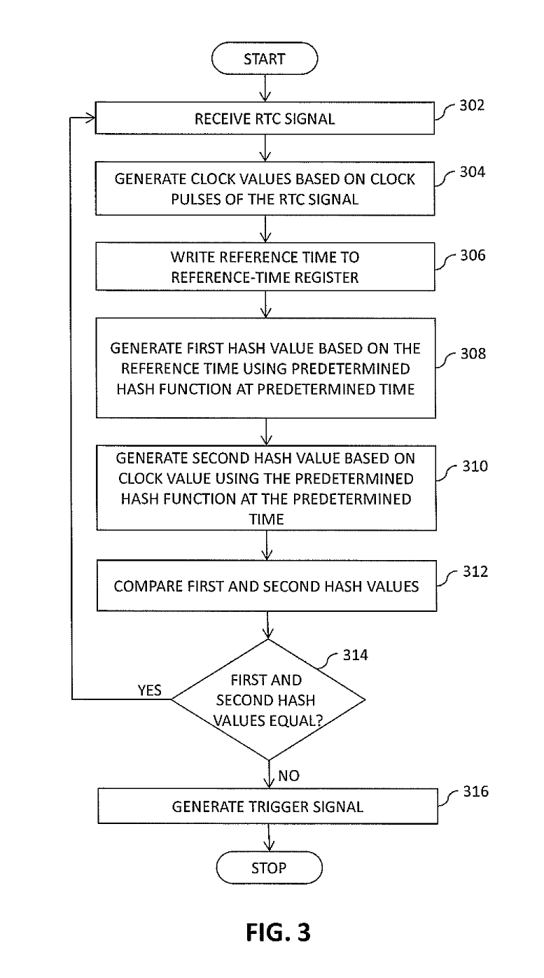

Referring now to FIG. 3, a flowchart illustrating a method to secure the RTC circuit 202 of the electronic system 204 in accordance with an embodiment of the present invention is shown. At step 302, the RTC counter 216 receives the RTC signal that is generated by the crystal oscillator 214. At step 304, the RTC counter 216 counts the number of clock pulses of the RTC signal and generates the plurality of clock values. At step 306, the reference-time register 208 receives and stores the plurality of reference time values at the first predetermined time interval.

At step 308, the hash-value generator 210 generates the first hash value based on the first reference time value and the second hash value based on the first clock value using the predetermined hash function. The hash-value generator 210 generates the first and second hash values at the second predetermined time intervals. At step 312, the first and second hash values are compared using the comparison module 212. At step 314, a check is performed to determine whether the first and second hash values are equal. If it is determined at step 314 that the first and second hash values are equal, steps 302-312 are repeated at a regular time interval as defined by system requirements. However, if at step 314, it is determined that the first and second hash values are unequal, step 316 is executed at which the comparison module 212 generates the trigger signal. The trigger signal indicates either a manipulation to the RTC circuit 202 or the reference time values generated by the network-clock generator 206 and prompts the electronic system 204 to delete any secured information stored therein.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A system for detecting modifications to a real-time clock (RTC) of an electronic device, comprising:
an RTC counter, for receiving an RTC signal and outputting a plurality of clock values that correspond to a plurality of clock pulses of the RTC signal;
a reference-time register, for receiving and storing a plurality of reference time values at a first predetermined time interval;
a hash-value generator, connected to the reference-time register and the RTC counter, for generating a first hash value based on a first reference time value of the plurality of reference time values and a second hash value based on a first clock value of the plurality of clock values, based on a predetermined hash function and at a second predetermined time interval; and
a comparator, connected to the hash-value generator, for comparing the first and second hash values and generating a trigger signal based on a mismatch between the first and second hash values, wherein the mismatch indicates modifications to the RTC.

2. The system of claim 1, further comprising a crystal oscillator for generating the RTC signal.

3. The system of claim 1, wherein the reference-time register is a write-only register.

4. The system of claim 1, wherein the predetermined hash function comprises a secure hash algorithm (SHA)-256.

5. The system of claim 1, wherein the first and second hash values each are 256-bit long.

6. The system of claim 1, wherein the plurality of clock and reference time values each are 64-bit long.

7. The system of claim 1, wherein the plurality of reference time values are generated externally by a network-clock generator.

8. The system of claim 7, wherein the RTC counter synchronizes with the network-clock generator by way of at least one of a network-time protocol (NTP) and a global positioning system (GPS) when the electronic device is powered up.

9. The system of claim 8, wherein the reference-time register receives the plurality of reference time values from the network-clock generator by way of the NTP.

10. A method for detecting modifications to a real-time clock (RTC) of an electronic device, comprising:
receiving an RTC signal by a RTC counter;
outputting a plurality of clock values that correspond to a plurality of clock pulses of the RTC signal by the RTC counter;
receiving a plurality of reference time values at a first predetermined time interval by a reference-time register;
generating a first hash value based on a first reference time value of the plurality of reference time values by a hash-value generator that is connected to the reference-time register and the RTC counter, based on a predetermined hash function and at a second predetermined time interval;
generating a second hash value based on a first clock value of the plurality of clock values by the hash-value generator, based on the predetermined hash function and at the second predetermined time interval;
comparing the first and second hash values by using a comparison module which is connected to the hash-value generator; and
generating a trigger signal by way of the comparison module, based on a mismatch between the first and second hash values, whereby the mismatch indicates modifications to the RTC.

11. The method of claim 10, wherein the RTC signal is generated by a crystal oscillator.

12. The method of claim 10, further comprising synchronizing the RTC counter with a network-clock generator by way of at least one of a network-time protocol (NTP) and a global positioning system (GPS) when the electronic device is powered up.

13. The method of claim 12, further comprising the reference-time register receiving the plurality of reference time values from the network-clock generator by way of the NTP.
